(19) United States
(12) Patent Application Publication
(10) Pub. No.: US 2010/0272306 A1
(43) Pub. Date: Oct. 28, 2010

(54) LOUDSPEAKER COVER

(75) Inventor: Willem Franciscus Johannes Hoogenstraaten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,532

(22) PCT Filed: Dec. 12, 2008
(86) PCT No.: PCT/IB2008/055246

§ 371 Date: Jun. 11, 2010

(30) Foreign Application Priority Data
Dec. 19, 2007 (EP) 07123604.6

(51) Int. Cl. H04R 1/02

(52) U.S. Cl. 381/386

(57) ABSTRACT

The present invention relates to a loudspeaker cover comprising a light guide arranged for receiving light from a light source, wherein the light guide comprises at least one hole to allow sound to be emitted through the cover, and wherein the at least one hole is arranged for dispersing the received light out of the light guide. The holes in the light guide may e.g. be cylindrical, conical, double-conical, or formed as grooves. The invention further relates to a loudspeaker housing comprising such a loudspeaker cover, and an electronic entertainment device comprising such a loudspeaker cover. In a preferred embodiment, the loudspeaker cover is positioned adjacent to a display. In case light is emitted that matches the contents being shown on the periphery of the display, this effect is even further enhanced in that the colors are perceived as leaking out of the display onto the loudspeaker cover. The effect of the dispersed light is a larger virtual display and a more immersive viewing experience.

### FIELD OF THE INVENTION

The present invention relates to a loudspeaker cover, a loudspeaker housing comprising such a loudspeaker cover, and an electronic entertainment device comprising such a loudspeaker cover.

### BACKGROUND OF THE INVENTION

U.S. Pat. No. 6,978,030 discloses a loudspeaker cover for covering a loudspeaker which is located within a housing. The loudspeaker cover comprises a plurality of horizontal and vertical optical fibers in a grid like form which is woven into e.g. a cloth material such as used for covers for known loudspeakers. A plurality of light sources supplies light to said optical fibers. The grid of horizontal and vertical optical fibers has air spaces through which sound waves generated by the loudspeaker can travel.

Such a loudspeaker cover has a complex construction and is expensive to manufacture. There is therefore a need for a further improvement for overcoming said disadvantages.

### BRIEF DESCRIPTION OF THE INVENTION

The object of the present invention is to provide a light emitting loudspeaker cover which has a simple construction.

According to one aspect the present invention relates to a loudspeaker cover comprising a light guide arranged for receiving light from a light source, wherein the light guide comprises at least one hole to allow sound to be emitted through the light guide, and wherein the at least one hole is arranged for dispersing the received light out of the light guide.

Thus, the present invention offers a brilliant, yet simple solution to overcoming said disadvantages. By using a loudspeaker cover according to the present invention, there is no need to use optical light fibers. Light which is received into the light guide is dispersed, or scattered, at least partly, out of the light guide when arriving at the holes. The holes therefore have a double function in the present invention; they allow sound to be emitted through the light guide, and they disperse light out of the light guide.

In one embodiment, the hole is defined by a boundary surface of the light guide that extends from a first side of the light guide from where the sound is emitted to a second side of the light guide onto which the sound is incident. The hole is thus not restricted to any size, shape, or extension as long as it extends through the light guide to allow sound to pass through it and to disperse light out of the light guide.

In another embodiment, the boundary surface is substantially cylindrical. This implies that a cross section area of the hole (in the perpendicular direction of the extension of the hole) is substantially circular. Holes are thus easily obtained by drilling.

In another embodiment, the boundary surface is sloped with respect to the first side, such that in use the light is dispersed out mostly to the first side. This has the advantage, compared to a non-sloped or non-inclined hole, that a viewer positioned in a perpendicular direction of the light guide is exposed to a larger, light emitting boundary surface of the hole. In the non-sloped case, most of the emitted light from the boundary surface of the hole is emitted in a direction along the plane of the light guide. Some light will of course be emitted out of the light guide and along the perimeter and the extension of the boundary surface of the hole. The viewer may thus perceive the light being emitted in his direction as coming from a light source being shaped as a circular rim. However, if the boundary surface is sloped with respect to the first side of the light guide, the viewer will thus be exposed to a larger boundary surface and consequently to more light coming out there from. An alternative way of expressing that the boundary surface is sloped with respect to the first side is that the direction of the extension of the hole is inclined with respect to the first side of the light guide.

In further embodiments, the at least one hole is larger on the first side of the light guide than on the second side of the light guide, or, if expressed more specifically and more narrowly, the boundary surface of the hole is substantially conical. This is advantageous in that the light may be dispersed in a wider angle in comparison to holes being substantially cylindrical. The light will thus be distributed more evenly instead of appearing to be point like light sources. Conical holes have the additional advantage of a lower acoustic resistance and acoustic mass of the holes, because the larger the average diameter is across the cone length of the hole, the much better. Another advantage is that conical holes are much easier obtained when manufactured by molding. The manufacturing is usually done with grids of metal pins, and in order to get the pins out of the mould they need to have a conical shape, the so-called release angle.

In further embodiments, the hole is at some point narrower than at the first and second side of the light guide, or, if expressed more specifically and more narrowly, the hole volume has substantially the form of a double-cone. In addition to the advantages stated above, an even more preferred way of manufacturing by molding is done with two grids of metal pins that are pressed towards each other in the mould. As the pins come from two sides, the hole shapes will be double-conical, with the smallest diameter usually somewhere in the middle.

In another embodiment, the hole, as seen as from the outside front of the cover, is formed as a groove. This construction is advantageous for the acoustic resistance (the total hole area on the light guide is increased), while it still maintains a good physical front protection for the loudspeaker. Another way of increasing the total hole area is by increasing the hole size of round holes, but this would then be disadvantageous for said physical front protection. Holes formed as grooves are thus a good compromise for achieving both purposes.

In another embodiment, the boundary surface at the line of intersection between the boundary surface and the first or second side is rounded. This construction also allows for more light to be dispersed towards a viewer who is positioned in front of a loudspeaker which comprises said loudspeaker cover. Holes with rounded edges are also preferred from an acoustic point of view as they reduce the minimum diameter that the air has to pass.

For all the embodiments above where the holes are not cylindrical but where at least a part of the boundary surface of the hole is faced in the direction of the hole opening at the first side of the light guide, more light is likely to be dispersed towards a viewer who is positioned in front of a loudspeaker which has said loudspeaker cover. This is due to the fact that the photons hitting the boundary surface of the hole are, at least to some extent, guided or directed by the inclination of said boundary surface. Naturally, the photons are dispersed in all directions, but the light distribution depends upon, among other things, the inclination or the direction of the boundary surface of the hole. An advantage of this embodiment is that the seemingly dark effect of the hole, at least in cases of a dark background positioned behind the light guide, will appear less visual to a viewer. The ratio between the surface areas emitting light and not emitting light will be increased.

In another embodiment, the light guide has a substantially planar shape. This is advantageous for the mainstream construction of loudspeakers usually having a front or a loudspeaker cover which is substantially of a planar shape.

In another embodiment, at least part of the boundary surface is coated with a light-sensitive or a light-dispersing material. This will further increase the amount of light being emitted from the boundary surface.

In another embodiment, the loudspeaker cover further comprises the light source for supplying the light to the light guide. E.g. a light-emitting diode (LED) may easily be comprised in the construction for supplying the light to the light guide. The light may be supplied directly to the light guide, via another light guide, or via any means for guiding light.

According to another aspect, the present invention relates to a loudspeaker housing comprising said loudspeaker cover.

According to another aspect, the present invention relates to an electronic entertainment device comprising said loudspeaker cover for covering a speaker associated with the electronic entertainment device. The loudspeaker cover is preferably used for any kind of device using acoustic transmitters, such as a TV, a mini or a micro stereo, a computer display, a mobile phone, an IPOD, an MP3-player, a PDA, or a portable DVD-player. Front illumination of said devices is becoming increasingly popular in order to enhance the visual appearance and stylish look. The present invention thus offers a very advantageous way of combining audio with light while still maintaining a clean design of said devices.

In one embodiment, the electronic entertainment device further comprises a display, wherein the dispersed light is arranged to represent the contents being shown on the display. The contents to be displayed is analyzed, and based thereon light is emitted that matches the contents being shown. Light-emitting loudspeakers may be placed anywhere in a room for this purpose, i.e. they will function both as loudspeakers and as so called light speakers.

In another embodiment, the loudspeaker cover is positioned adjacent to the display. The effect of the dispersed light is a larger virtual display and a more immersive viewing experience. In case light is emitted that matches the contents being shown on the periphery of the display, this effect is even further enhanced in that the colors are perceived as ‘leaking’ out of the display onto the loudspeaker cover.

Another advantage is related to the visual effect called AmbiLight, a feature which is employed only in TVs from Philips. Until recently, AmbiLight has only been a wall illumination system. When demonstrating AmbiLight in brightly illuminated environments, and on colored walls, the effect is largely deteriorated resulting in pale colors around the screen. Especially in shop environments this effect is very undesirable. A self illuminating surface has a much better visibility than an illuminated surface on which light is projected. Therefore, the loudspeaker cover in the present invention offers an intelligent solution to this problem, as well as to the key problem of integration of sound, as it requires a substantial surface to obtain sufficient sound quality. Another advantage is that the AmbiLight feature is not dependent on the presence or the color of a wall anymore. A further reason to illuminate the loudspeaker cover is to bring the light effect closer to the screen, which is easier achieved when the loudspeaker cover, being part of the overall construction is also illuminated.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1a shows a perspective view of a loudspeaker housing having a loudspeaker cover according to the present invention,

FIG. 1b shows a perspective view of a loudspeaker cover according to the present invention comprising a light source and a linear light guide for supplying light to the loudspeaker cover, and

FIGS. 2a, 2b and 3 show a perspective view of a loudspeaker cover comprising holes of different shapes according to different embodiments of the present invention.

### DESCRIPTION OF EMBODIMENTS

The conventional purpose of loudspeaker covers is to provide a physical protection for the components in the loudspeaker housing, but the aesthetical appearance is also of importance as the loudspeaker cover usually faces the user. The loudspeaker cover must thus allow sound waves to pass efficiently while still fulfilling the protective and the aesthetical purposes of the loudspeaker cover.

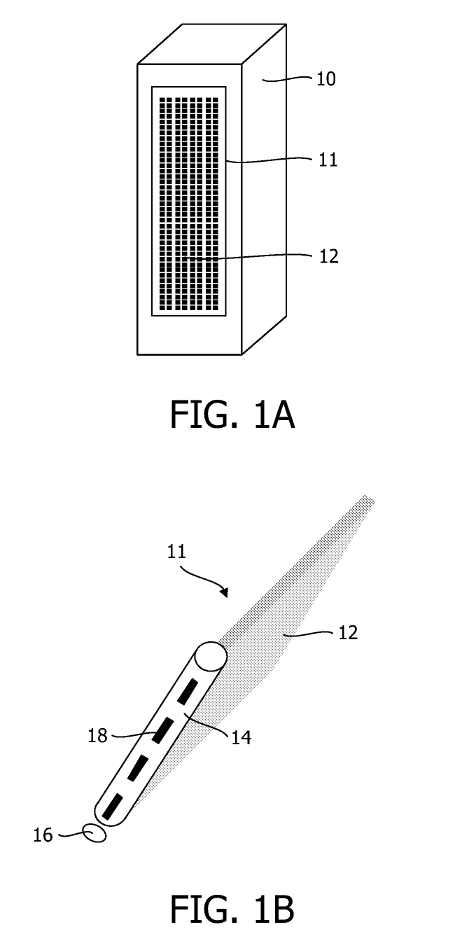

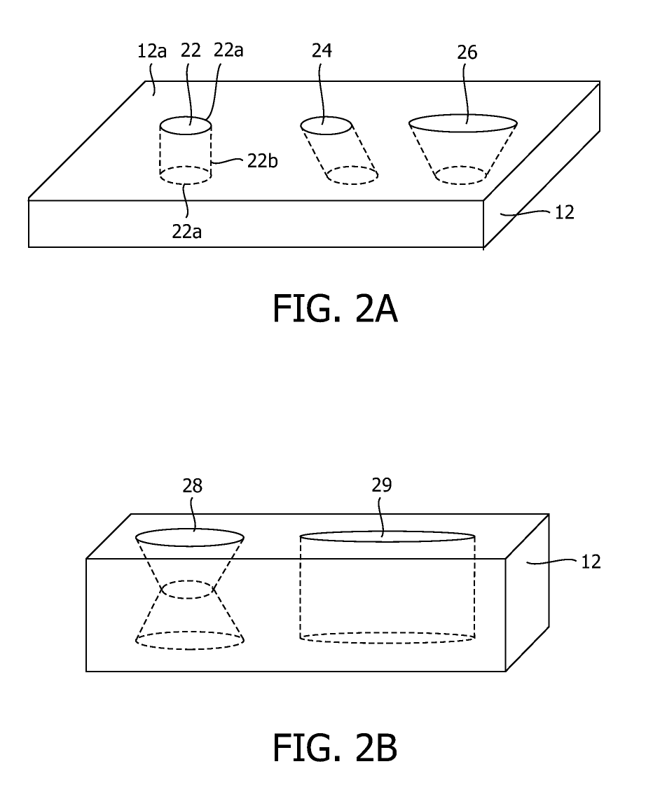

FIG. 1a shows a loudspeaker housing 10 having a loudspeaker cover 11 according to the present invention. The loudspeaker cover 11 comprises a light guide 12. Not shown in FIG. 1a are also various components, such as a loudspeaker or a transducer, for generating sound waves to be emitted from within the loudspeaker housing 10 through the light guide 12. The loudspeaker cover 11 may be used for covering a loudspeaker in a standalone loudspeaker housing 10 as in FIG. 1a, but could also be used for covering a loudspeaker comprised in any kind of electronic entertainment device using acoustic transmitters, such as a TV, a mini or a micro stereo, a computer display, a mobile phone, an IPOD, an MP3-player, a PDA, or a portable DVD-player.

A plurality of holes in the light guide 12 is shown in FIG. 1a. In the present invention the holes have a double function. In addition to allowing the sound waves generated within the loudspeaker housing 10 to pass through the light guide 12, they are also designed to disperse light out of the light guide 12. The principle of the holes dispersing light will be more understood in the following.

FIG. 1b shows a perspective view of the loudspeaker cover 11 according to the present invention comprising a light source 16 and a linear light guide 14 for supplying and guiding light to the planar light guide 12. The planar light guide 12 is made of e.g. PMMA or any material which is suitable for guiding light. The present invention is not limited to light guides which are planar, but they may be of any shape which is suitable for covering an acoustic transmitter such as a loudspeaker. The skilled person may easily conceive light guides which have a curved, or an irregular surface.

A point light source 16, e.g. one or more LEDs, supplies light into one or both ends of the linear light guide 14 to create a linear light source. The linear light guide 14 in turn supplies light into the planar light guide 12. The light may of course also be supplied directly by the LEDs into the planar light guide 12, e.g. by an array of LEDs, or any kind of linear light source may be used for that purpose.

Because of the principle of Total Internal Reflection (TIR) any flat piece of transparent material will function as a light guide. A transparent material with a highly reflective (polished) surface is preferred. Light being injected into the thin side of the material will not be able to escape as it reflects on both top and bottom surfaces, provided these surfaces are ‘optically flat’. The moment a light ray hits a surface at a large enough angle, it will escape from the light guide 12. The principle of TIR is lossless, and hence large distances can be covered in this way, only limited by the internal absorption of the material. Being lossless however means that from a top view, the light guide 12 is dark, no light is emitted upwards. One way of achieving this, is by applying patterns 18 onto the surface of the material.

Any disturbance 18 of the surface layer will extract light from the light guide 12. Sandblasting a surface, or applying layers of paint, may make such disturbances 18 as shown on the linear light guide 14 in FIG. 1B. More or bigger structures will extract more light. Even a simple scratch on the surface will cause light to escape. A hole through the light guide should thus be considered as a bigger structure and will extract light efficiently. Hence, the gist of the present invention is to provide a light guide 12 as a loudspeaker cover which comprises holes for dispersing the injected light and for allowing sound to pass through said loudspeaker cover.

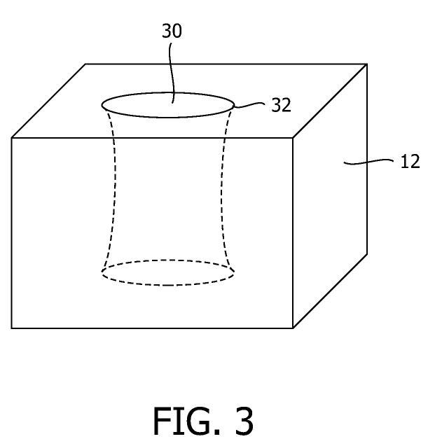

FIG. 2a shows a perspective view of a light guide 12 comprising a cylindrical hole 22 according to one embodiment of the present invention. The hole 22 is defined by a boundary surface 22b of the light guide 12 that extends from a first side 12a of the light guide 12 from where the sound is emitted to a second side (the opposite side) of the light guide 12 onto which the sound is incident. The second side is thus facing the loudspeaker which normally is placed within a housing, and the first side 12a is facing the exterior of the loudspeaker, normally a user of the loudspeaker.

FIG. 2a further shows a hole 24 having a boundary surface which is sloped, i.e. a cylindrical hole which is sloped, and a hole 26 which is larger on the first side 12a of the light guide 12 than on the second side (the opposite side of 12a) of the light guide 12, i.e. a conical hole.

FIG. 2b shows a light guide 12 with a hole 28 which is double-conical, and a hole 29 which is formed as a groove, when seen from the outside front of the loudspeaker cover 11.

FIG. 3 shows a light guide 12 with a hole 30, wherein the boundary surface at the line of intersection 32 between the boundary surface and the first or second side is rounded. An alternative way of expression is that the hole edge is rounded.

The invention is not limited to holes with a perfect symmetry, e.g. the boundary surface could have an irregular surface, or the larger hole 26 in FIG. 2a could be placed out of the line of symmetry with the smaller hole. The holes may be distributed in the light guide with a certain, but not necessarily regular, grid pattern. Not all holes need to be drilled through as long as the part covering the loudspeaker is. One prototype of a light guide having a grid of holes with a diameter of approximately 1 mm and being spaced apart by approximately 2 mm proved to be successful for dispersing light and allowing sound to pass. However, holes of any sizes and any hole density distribution also serves its purposes. It was also proven to be successful for the contrast of the light being emitted to have the rear of the loudspeaker cover mounted with a dark surface in order to absorb external light coming in through the light guide 12.

In case the loudspeaker cover is positioned adjacent to a display, the dispersed light may be arranged to represent the contents being shown on the display. A central control unit is coupled to the light source and operates the light source by analyzing the incoming video signal of the image to be displayed on the periphery of the display and based thereon emits light to the loudspeaker cover that matches the video being shown. This embodiment is not limited to video, but works for any content being shown on the display, such as still pictures.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims; however the inclusion of the reference signs is only for clarity reasons and should not be construed as limiting the scope of the claims.

1. A loudspeaker cover 11 comprising a light guide 12 arranged for receiving light from a light source 16, wherein
the light guide 12 comprises at least one hole to allow sound to be emitted through the light guide 12, and wherein the at least one hole is arranged for dispersing the received light out of the light guide 12.

2. A loudspeaker cover 11 according to claim 1, wherein the hole is defined by a boundary surface 22b of the light guide 12 that extends from a first side 12a of the light guide 12 from where the sound is emitted to a second side of the light guide 12 onto which the sound is incident.

3. A loudspeaker cover 11 according to claim 2, wherein the boundary surface 22b is substantially cylindrical.

4. A loudspeaker cover 11 according to claim 2, wherein the boundary surface is sloped with respect to the first side 12a, such that in use the light is dispersed out mostly to the first side 12a.

5. A loudspeaker cover 11 according to claim 2, wherein the at least one hole 26 is larger on the first side of the light guide 12 than on the second side of the light guide 12.

6. A loudspeaker cover 11 according to claim 5, wherein the boundary surface is substantially conical.

7. A loudspeaker cover 11 according to claim 2, wherein the at least one hole 28 is at some point narrower than at the first and second side of the light guide 12.

8. A loudspeaker cover 11 according to claim 7, wherein the hole volume has substantially the form of a double-cone.

9. A loudspeaker cover 11 according to claim 1, wherein the at least one hole 29, as seen as from the outside front of the loudspeaker cover 11, is formed as a groove.

10. A loudspeaker cover 11 according to claim 2, wherein the boundary surface at the line of intersection 32 between the boundary surface and the first or second side is rounded.

11. A loudspeaker cover 11 according to claim 1, wherein the light guide 12 has a substantially planar shape.

12. A loudspeaker cover 11 according to claim 2, wherein at least a part of the boundary surface is coated with a light-sensitive or a light-dispersing material.

13. A loudspeaker cover 11 according to claim 1, further comprising the light source 16 for supplying the light to the light guide 12.

14. A loudspeaker housing 10 comprising a loudspeaker cover 11 according to claim 1.

15. An electronic entertainment device comprising a loudspeaker cover 11 according to claim 1 for covering a speaker associated with the electronic entertainment device.

16. An electronic entertainment device according to claim 15, further comprising a display, wherein the dispersed light is arranged to represent the contents being shown on the display.

17. An electronic entertainment device according to claim 15, wherein the loudspeaker cover 11 is positioned adjacent to the display.
